(19) United States
(12) Patent Application Publication
(10) Pub. No.: US 2022/0027709 A1
(43) Pub. Date: Jan. 27, 2022

(54) DATA DENOISING BASED ON MACHINE LEARNING

(71) Applicant: Nokia Technologies Oy, Espoo (FI)

(72) Inventor: Mikko HONKALA, Espoo (FI)

(21) Appl. No.: 17/311,895

(22) PCT Filed: Dec. 18, 2018
(86) PCT No.: PCT/FI2018/050936

§ 371 Date: Jun. 8, 2021

(51) Int. Cl. G06N 3/04; G06K 9/00; G06N 3/08

(52) U.S. Cl. CPC G06N 3/0454; G06N 3/08; G06K 9/00979

(57) ABSTRACT

Systems, apparatuses, and methods are described for configuring denoising models based on machine learning. A denoising model (301) may remove noise from data samples (451). A noise model (403) may include noise in the data samples. Data samples processed by the denoising model (453) and/or the noise model (455) and original data samples (457) may be input into a discriminator (405). The discriminator may make determinations to classify input data samples. The denoising model and/or the discriminator may be trained based on the determinations.

### BACKGROUND

Denoising models may be used to remove noise from data samples. Machine learning (ML), such as deep learning, may be used to train denoising models as neural networks. Denoising models may be trained based on data samples.

### BRIEF SUMMARY

This Summary is provided to introduce a selection of concepts in a simplified form that are further described below in the Detailed Description. This Summary is not intended to identify key features or essential features of the various embodiments, nor is it intended to be used to limit the scope of the claims.

Systems, apparatuses, and methods are described for configuring denoising models based on machine learning. A computing device may receive a first set of noisy data samples and a second set of noisy data samples. The noisy data samples may be corrupted by a known or unknown noise process. The computing device may denoise, using a first neural network comprising a first plurality of parameters, the first set of noisy data samples to generate a set of denoised data samples. The computing device may process, using a noise model, the set of denoised data samples to generate a third set of noisy data samples. The computing device may determine, using a second neural network and based on the second set of noisy data samples and the third set of noisy data samples, a discrimination value. The computing device may adjust, based on the discrimination value, the first plurality of parameters.

In some examples, the first set of noisy data samples may comprise one or more first noisy images, one or more first noisy videos, one or more first noisy 3D scans, or one or more first noisy audio signals. The second set of noisy data samples may comprise one or more second noisy images, one or more second noisy videos, one or more second noisy 3D scans, or one or more second noisy audio signals. In some examples, the computing device may train, based on additional noisy data samples and by further adjusting the first plurality of parameters, the first neural network, such that the discrimination value approaches a predetermined value.

After the training of the first neural network, the computing device may receive a noisy data sample. The computing device may denoise, using the trained first neural network, the noisy data sample to generate a denoised data sample. The computing device may present to a user, or send for further processing, the denoised data sample.

In some examples, the computing device may train, based on additional noisy data samples and by further adjusting the first plurality of parameters, the first neural network, such that the discrimination value approaches a predetermined value. After the training of the first neural network, the computing device may deliver the trained first neural network to a second computing device. The second computing device may receive a noisy data sample from a sensor of the second computing device. The second computing device may denoise, using the trained first neural network, the noisy data sample to generate a denoised data sample. The second computing device may present to a user, or send for further processing, the denoised data sample. In some examples, the first set of noisy data samples and the second set of noisy data samples may be received from a same source. In some examples, the first set of noisy data samples, the second set of noisy data samples, and the noisy data sample may be received from similar sensors. In some examples, the trained first neural network may be a trained denoising model.

In some examples, the first neural network and the second neural network may comprise a generative adversarial network. In some examples, the second neural network comprises a second plurality of parameters. The adjusting the first plurality of parameters may be based on fixing the second plurality of parameters. The computing device may adjust the second plurality of parameters based on fixing the first plurality of parameters. In some examples, the discrimination value may indicate a probability, or a scalar quality value, of a noisy data sample of the second set of noisy data samples or of the third set of noisy data samples belonging to a class of real noisy data samples or a class of fake noisy data samples.

In some examples, the computing device may determine, based on a type of a noise process through which the first set of noisy data samples and the second set of noisy data samples are generated, one or more noise types. The computing device may determine, based on the one or more noise types, the noise model corresponding to the noise process. In some examples, the noise model may comprise a machine learning model, such as a third neural network, comprising a third plurality of parameters. The computing device may receive a set of reference noise data samples. The computing device may generate, using the noise model, a set of generated noise data samples. The computing device may train, using machine learning and based on the set of reference noise data samples and the set of generated noise data samples, the noise model.

In some examples, the noise model may comprise a modulation model configured to modulate data samples to generate noisy data samples. The machine learning model, such as the third neural network, may output one or more coefficients to the modulation model. In some examples, the noise model may comprise a convolutional model configured to perform convolution functions on data samples to generate noisy data samples. The machine learning model, such as the third neural network, may output one or more parameters to the convolutional model. In some examples, the computing device may train, using machine learning, one or more machine learning models, such as neural networks, corresponding to one or more noise types. The computing device may select, from the one or more machine learning models, a machine learning model to be used as the noise model.

In some examples, the computing device may receive a fourth set of noisy data samples and a fifth set of noisy data samples. Each noisy data sample of the fourth set of noisy data samples may comprise a first portion and a second portion (and/or any other number of portions). The computing device may denoise, using the first neural network, the first portion of each noisy data sample of the fourth set of noisy data samples. The computing device may process, using the noise model, the denoised first portion of each noisy data sample of the fourth set of noisy data samples. The computing device may determine, using the second neural network and based on the processed denoised first portions, the second portions, and the fifth set of noisy data samples, a second discrimination value. The computing device may adjust, based on the second discrimination value, the first plurality of parameters.

In some examples, a second computing device may receive a denoising model. The denoising model may be trained using a generative adversarial network. The second computing device may receive a noisy data sample from a noisy sensor. The denoising model may be trained for a sensor similar to the noisy sensor. The second computing device may denoise, using the denoising model, the noisy data sample to generate a denoised data sample. The second computing device may present to a user, or send for further processing, the denoised data sample. The further processing may comprise at least one of image recognition, object recognition, natural language processing, voice recognition, or speech-to-text detection.

In some examples, a computing device may comprise means for receiving a first set of noisy data samples and a second set of noisy data samples. The computing device may comprise means for denoising, using a first neural network comprising a first plurality of parameters, the first set of noisy data samples to generate a set of denoised data samples. The computing device may comprise means for processing, using a noise model, the set of denoised data samples to generate a third set of noisy data samples. The computing device may comprise means for determining, using a second neural network and based on the second set of noisy data samples and the third set of noisy data samples, a discrimination value. The computing device may comprise means for adjusting, based on the discrimination value, the first plurality of parameters.

Additional examples are discussed below.

### BRIEF DESCRIPTION OF THE DRAWINGS

Some example embodiments are illustrated by way of example and not limited in the accompanying figures in which like reference numerals indicate similar elements and in which:

FIG. 1 is a schematic diagram showing an example embodiment of a neural network with which features described herein may be implemented.

FIG. 2 is a schematic diagram showing another example embodiment of a neural network with which features described herein may be implemented.

FIG. 3A is a schematic diagram showing an example embodiment of a process for denoising data samples.

FIG. 3B is a schematic diagram showing an example embodiment of a neural network which may implement a denoising model.

FIG. 4 is a schematic diagram showing an example embodiment of a process for training a denoising model based on noisy data samples.

FIG. 5 is a schematic diagram showing an example embodiment of a discriminator.

FIGS. 6A-B are a flowchart showing an example embodiment of a method for training a denoising model.

FIG. 7 is a schematic diagram showing an example embodiment of a process for training a noise model.

FIG. 8 is a schematic diagram showing another example embodiment of a process for training a noise model.

FIG. 9 is a schematic diagram showing another example embodiment of a process for training a noise model.

FIG. 10 shows an example embodiment of a process for training a denoising model based on processing partial data samples.

FIG. 11 shows an example embodiment of an apparatus that may be used to implement one or more aspects described herein.

### DETAILED DESCRIPTION

In the following description of various illustrative embodiments, reference is made to the accompanying drawings, which form a part hereof, and in which are shown by way of illustration various embodiments in which the disclosure may be practiced. It is to be understood that other embodiments may be utilized and structural and functional modifications may be made without departing from the scope of the present disclosure.

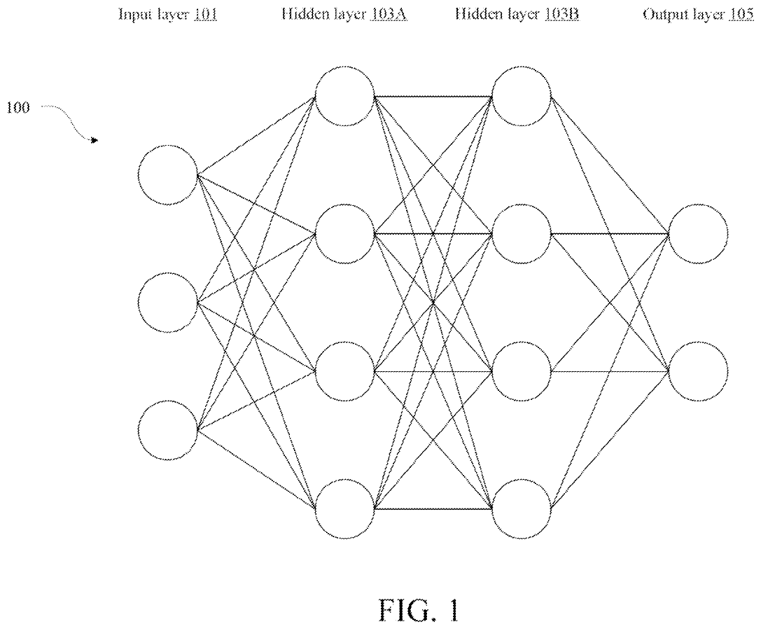

FIG. 1 is a schematic diagram showing an example neural network 100 with which features described herein may be implemented. The neural network 100 may comprise a multilayer perceptron (MLP). The neural network 100 may include one or more layers (e.g., input layer 101, hidden layers 103A-103B, and output layer 105). There may be additional or alternative hidden layers in the neural network 100. Each of the layers may include one or more nodes. The nodes in the input layer 101 may receive data from outside the neural network 100. The nodes in the output layer 105 may output data to outside the neural network 100.

Data received by the nodes in the input layer 101 may flow through the nodes in the hidden layers 103A-103B to the nodes in the output layer 105. Nodes in one layer (e.g., the input layer 101) may associate with nodes in a next layer (e.g., the hidden layer 103A) via one or more connections. Each of the connections may have a weight. The value of one node in the hidden layers 103A-103B or the output layer 105 may correspond to the result of applying an activation function to a sum of the weighted inputs to the one node (e.g., a sum of the value of each node in a previous layer multiplied by the weight of the connection between the each node and the one node). The activation function may be a linear or non-linear function. For example, the activation function may include a sigmoid function, a rectified linear unit (ReLU), a leaky rectified linear unit (Leaky ReLU), etc.

The neural network 100 may be used for various purposes. For example, the neural network 100 may be used to classify images showing different objects (e.g., cats or dogs). The neural network 100 may receive an image via the nodes in the input layer 101 (e.g., the value of each node in the input layer 101 may correspond to the value of each pixel of the image). The image data may flow through the neural network 100, and the nodes in the output layer 105 may indicate a probability that the image shows a cat and/or a probability that the image shows a dog.

The connection weights and/or other parameters of the neural network 100 may initially be configured with random values. Based on the initial connection weights and/or other parameters, the neural network 100 may generate output values different from the ground truths. The ground truths may be, for example, the reality that an administrator or user would like the neural network 100 to predict, etc. For example, the neural network 100 may determine a particular image shows a cat, when in fact the image shows a dog. To optimize its output, the neural network 100 may be trained by adjusting the weights and/or other parameters (e.g., using backpropagation). For example, the neural network 100 may process one or more data samples, and may generate one or more corresponding outputs. One or more loss values may be calculated based on the outputs and the ground truths. The weights and/or other parameters of the neural network 100 may be adjusted starting from the output layer 105 to the input layer 101 to minimize the loss value(s). In some embodiments, the weights and/or other parameters of the neural network 100 may be determined as described herein.

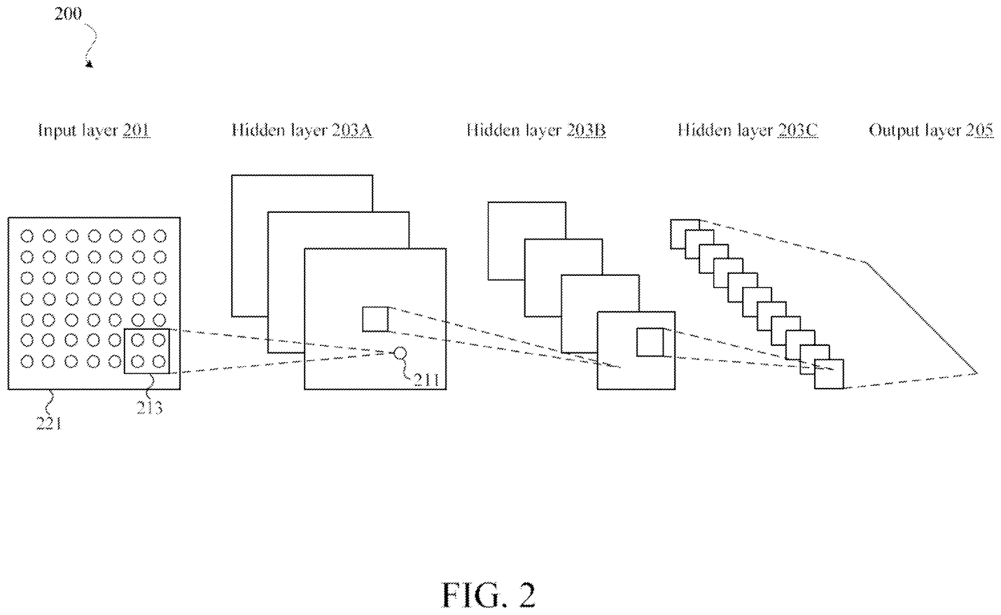

FIG. 2 is a schematic diagram showing another example neural network 200 with which features described herein may be implemented. The neural network 200 may comprise a deep neural network, e.g., a convolutional neural network (CNN). The neural network 200 may include one or more layers (e.g., input layer 201, hidden layers 203A-203C, and output layer 205). There may be additional or alternative hidden layers in the neural network 200. Similar to the neural network 100, each layer of the neural network 200 may include one or more nodes.

The value of a node in one layer may correspond to the result of applying a convolution function to a particular region (e.g., a receptive field including one or more nodes) in a previous layer. For example, the value of the node 211 in the hidden layer 203A may correspond to the result of applying a convolution function to the receptive field 213 in the input layer 201. One or more convolution functions may be applied to each receptive field in one layer, and the values of the nodes in the next layer may correspond to the results of the functions. Each layer of the neural network 200 may include one or more channels (e.g., channel 221), and each channel may include one or more nodes. The channels may correspond to different features (e.g., a color value (red, green, or blue), a depth, an albedo, etc.).

Additionally or alternatively, the nodes in one layer may be mapped to the nodes in a next layer via one or more other types of functions. For example, a pooling function may be used to combine the outputs of node clusters in one layer into a single node in a next layer. Other types of functions, such as deconvolution functions, Leaky ReLU functions, depooling functions, etc., may also be used. In some embodiments, the weights and/or other parameters (e.g., the matrices used for the convolution functions) of the neural network 200 may be determined as described herein. The neural networks 100 and 200 may additionally or alternatively be used in unsupervised learning settings, where the input layers and output layers may be of the same size, and the task for training may be, for example, to reconstruct an input through a bottleneck layer (a dimensionality reduction task) or to recover a corrupted input (a denoising task).

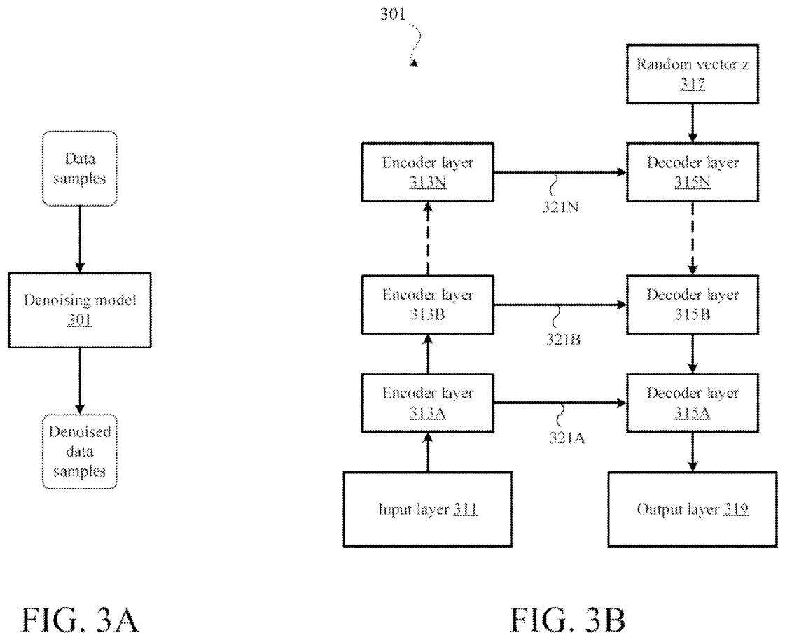

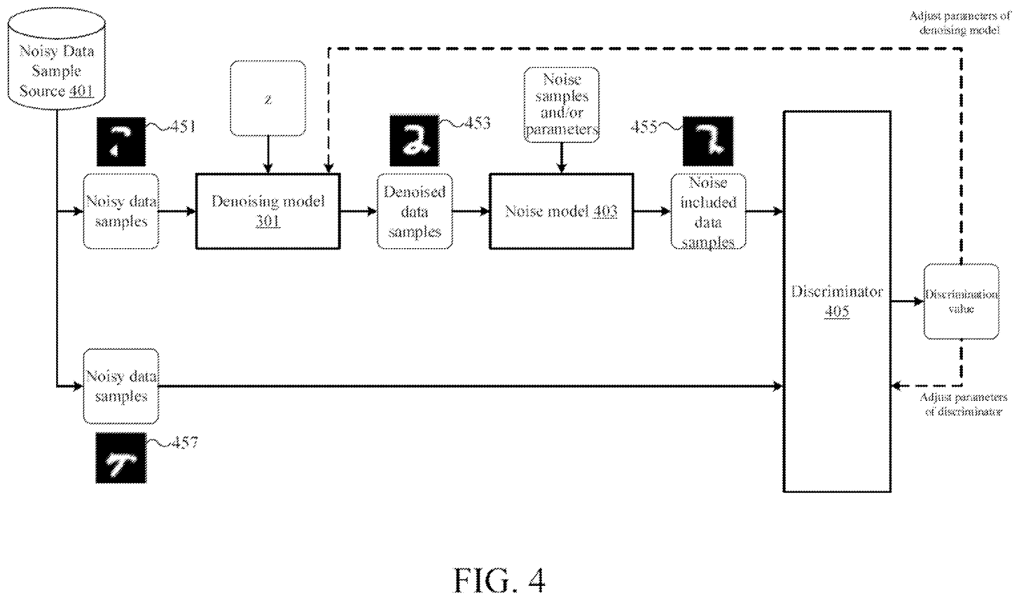

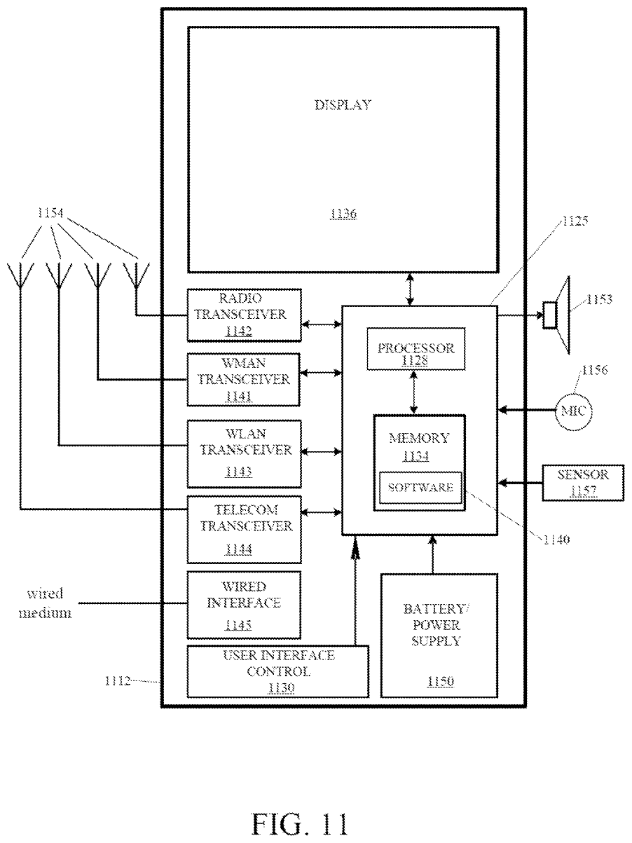

FIG. 3A is a schematic diagram showing an example process for denoising data samples. The process may be implemented by an apparatus, e.g., one or more computing devices (e.g., the computing device described in connection with FIG. 11). The process may be distributed across multiple computing devices, or may be performed by a single computing device. The process may use a denoising model 301. The denoising model 301 may receive data samples including noise, may remove noise from the data samples, and may generate denoised data samples corresponding to the noisy data samples. The denoising model 301 may take various forms to denoise various types of data samples, such as images, audio signals, video signals, 3D scans, radio signals, photoplethysmogram (PPG) signals, optical coherence tomography (OCT) images, X-ray medical images, electroencephalography (EEG) signals, astronomical signals, other types of digitized sensor signals, and/or any combination thereof. The denoised data samples may be presented to users and/or used for other purposes, such as an input for another process. The denoising model 301 may be implemented using any type of framework, such as an artificial neural network (ANN), a multilayer perceptron (e.g., the neural network 100), a convolutional neural network (e.g., the neural network 200), a recurrent neural network, a deep neural network, or any other type of neural network.

FIG. 3B is a schematic diagram showing an example neural network which may implement the denoising model 301 (e.g., based on a feature pyramid network model). The denoising model 301 may include an input layer 311, one or more hidden layers (e.g., the encoder layers 313A-313N and the decoder layers 315A-315N), a random vector z 317, and an output layer 319. Each layer of the denoising model 301 may include one or more nodes (not shown). The nodes in the input layer 311 may receive a data sample (e.g., an image, an audio signal, a video signal, a 3D scan, etc.). The received data may flow through the encoder layers 313A-313N and the decoder layers 315A-315N to the output layer 319. The output layer 319 may output a denoised data sample corresponding to the received data sample.

The denoising model 301 may comprise the form of an autoencoder. The input layer 311 and the encoder layers 313A-313N may comprise an encoder of the autoencoder. The output layer 319 and the decoder layers 315A-315N may comprise a decoder of the autoencoder. The encoder of the autoencoder may map an input data sample to a short code (e.g., the values of the nodes in the encoder layer 313N). The short code may be sent to the decoder layer 315N via the connection 321N. The decoder of the autoencoder may map the short code back to an output data sample corresponding to (e.g., closely matching, with noise removed from, etc.) the input data sample.

The random vector z 317 may also be input into the decoder layer 315N. For example, values of the nodes in the decoder layer 315N may correspond to the sum of the short code (e.g., the values of the nodes in the encoder layer 313N) and the values of the random vector z 317. Additionally or alternatively, the random vector z 317 may first be mapped (e.g., projected) to a number of nodes, and the values of the nodes in the decoder layer 315N may correspond to the sum of the values of the number of nodes and the values of the nodes in the encoder layer 313N. The random vector z 317 may comprise a set of one or more random values. As one example, the random vector z 317 may comprise a vector (0.21, 0.87, 0.25, 0.67, 0.58), the values of which may be determined randomly, for example, by sampling each component independently from a uniform or Gaussian distribution. The random vector z 317 may allow the denoising model 301 to generate one or more possible output data samples corresponding to an input data sample (e.g., by configuring different value sets for the random vector z 317), and thus may allow the denoising model 301 to model the whole probability distribution.

The nodes in one layer (e.g., the input layer 311) of the denoising model 301 may be mapped to the nodes in a next layer (e.g., the encoder layer 313A) via one or more functions. For example, the nodes in the input layer 311 may be mapped to the nodes in the encoder layer 313A, and the nodes in one encoder layer may be mapped to the nodes in a next encoder layer, via convolution functions, Leaky ReLU functions, pooling functions, and/or other types of functions. The nodes in one decoder layer may be mapped to the nodes in a next decoder layer, and the nodes in the decoder layer 315A may be mapped to the nodes in the output layer 319, via deconvolution functions, Leaky ReLU functions, depooling functions, and/or other types of functions. The denoising model 301 may include one or more skip connections (e.g., skip connections 321A-321N). For example, a skip connection may allow the values of the nodes in an encoder layer (e.g., the encoder layer 313A) to be added to the nodes in a corresponding decoder layer (e.g., the decoder 315A). The denoising model 301 may additionally or alternatively include skip connections inside the encoder and/or skip connections inside the decoder, similar to a residual net (ResNet) or dense net (DenseNet).

Noisy data samples may be received by the nodes in the input layer 311, and denoised data samples may be generated by the nodes in the output layer 319. To optimize the output of the denoising model 301 (e.g., to improving the performance of its denoising function), the denoising model 301 may be trained based on one or more pairs of noisy data samples and corresponding clean data samples (e.g., using a supervised learning method). The clean data samples may be, for example, data samples, obtained using sensor devices, with an acceptable level of quality (e.g., signal-to-noise ratio satisfying a threshold). This may result in the system's dependence on the ability to obtain clean data samples (e.g., using sensor devices).

Using Generative Adversarial Networks (GANs) may help alleviate the challenges discussed above. Based on a GAN framework, clean data samples (e.g., obtained via sensor devices) are not necessary for training the denoising model 301. The denoising model 301 may be implemented as the generator of a GAN, and may process noisy data samples obtained, for example, via sensor measurements. A noise model may include noise in the output data samples of the denoising model 301. Noisy data samples generated by the noise model and noisy data samples obtained via sensor measurements may be sent to a discriminator of the GAN. The discriminator may make predictions of whether input data samples belong to a class of real noisy data samples (e.g., obtained via sensor measurements) or a class of fake noisy data samples (e.g., generated by the noise model). The discriminator's predictions may be compared with the ground truths of whether the input data samples correspond to real noisy data samples or fake noisy data samples. Based on the comparison, the denoising model (as the generator) and/or the discriminator may be trained by adjusting their weights and/or other parameters (e.g., using backpropagation).

Benefits and improvements of example embodiments described herein may comprise, for example: fast and cheap training without a clean data samples; fast adjustment of previously trained denoising model; near real-time training a denoising model with streaming data; training in an end-user device (such as a vehicle or a mobile phone) without massive data collection and storage need; more accurate and error free sensor data; better sensor data analysis; better object recognition in images and video; better voice recognition; better location detection; etc.

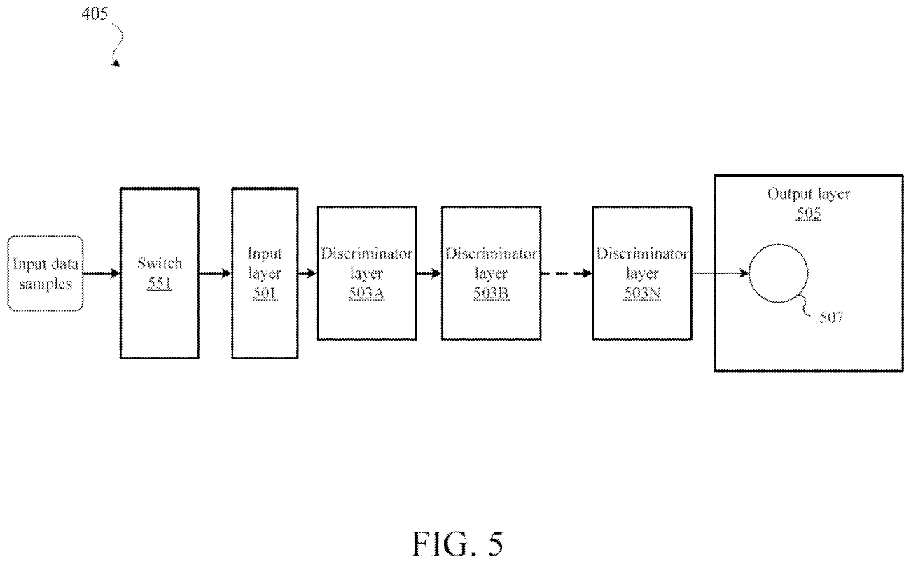

FIG. 4 is a schematic diagram showing an example process for training a denoising model with noisy data samples by using the GAN process. For example, the process may be used for training a denoising model based on only noisy data samples (e.g., clean data samples are not necessary). The process may be implemented by one or more computing devices (e.g., the computing device described in connection with FIG. 11). The process may be distributed across multiple computing devices, or may be performed by a single computing device. The process may use a noisy data sample source 401, the denoising model 301 (e.g. a generator), a noise model 403, and a discriminator 405. The noisy data sample source 401 may include any type of database or storage configured to store data samples (e.g., images, audio signals, video signals, 3D scans, etc.). The noisy data sample source 401 may store noisy data samples, obtained via sensor measurements, for training the denoising model 301. Alternatively or additionally, noisy data samples may be received by the denoising model 301 from one or more sensor devices in a real-time manner enabling real-time training of the denoising model 301. For example, a device (e.g., a user device, an IoT (internet of things) device) associated with sensors may receive data samples obtained by the sensors (e.g., periodically and/or in real-time), and the received data samples may be used for training a denoising model (e.g., in real-time). Additionally or alternatively, a device (with or without sensors) may receive data samples (e.g., in real-time from the noisy data sample source 401), and the received data samples may be used for training a denoising model (e.g., in real-time). The denoising model 301, the noise model 403, and the discriminator 405 may be implemented with a single processor or circuity, or alternatively they may have two or more separate and dedicated processors or circuitries. In a similar manner, they may have a single memory unit, or two or more separate and dedicated memory units.

Additionally or alternatively, the processes related to training a denoising model with only noisy data samples may be combined with processes related to training a denoising model based on pairs of noisy data samples and corresponding clean data samples. For example, a denoising model may be trained partly based on pairs of noisy and clean data, and partly based on noisy data only.

Data samples to be stored in the noisy data sample source 401 may be measured and/or obtained using one or more various types of sensors from various types of environment and/or space (e.g., a factory, a room, such as an emergency room, a home, a vehicle, etc.). For example, the noisy data sample source 401 may store a plurality of images captured by one or more cameras, a plurality of audio signals recorded by one or more recording devices, a plurality of medical images captured by one or more medical devices, a plurality of sensor signals captured by one or more medical devices, etc. The data measured or obtained using one or more sensors may be noisy or corrupted. For example, in photography, the imperfections of the lens in an image sensor may cause noise in the resulting images. In low light situations, sensor noise may become high and may cause various types of noise. As another example, photoplethysmograms may include noise caused by a movement of the photoplethysmogram sensor in a skin contact, background light or photodetector noise, or any combination thereof. External noise sources (e.g., background noise, atmosphere, heat, etc.) may introduce noise into measured data samples. As an example, speech data samples may include speech of persons and/or background noise of many types.

The noisy data sample source 401 may send noisy data samples to the denoising model 301 and the discriminator 405. The denoising model 301 may remove noise from the noisy data samples received from the noisy data sample source 401, and may generate denoised data samples corresponding to the noisy data samples. The denoised data samples may be processed by the noise model 403. The noise model 403 may include noise in the denoised data samples, and may generate noise included data samples.

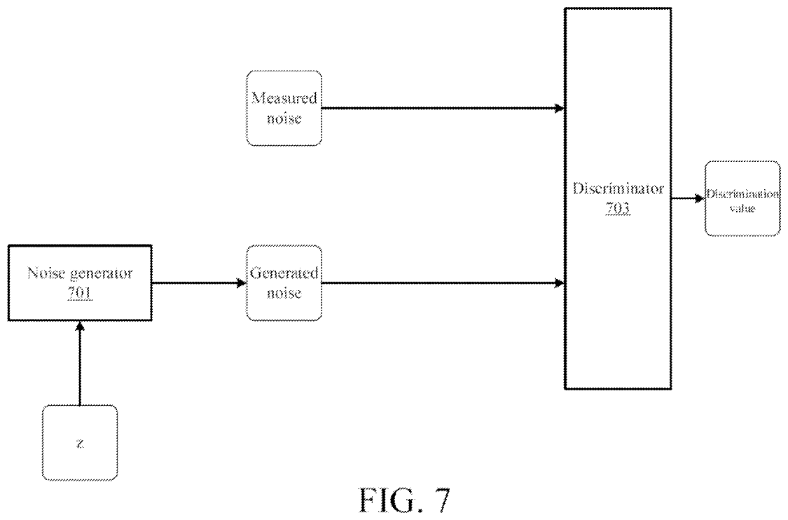

The noise model 403 may comprise a machine learning model or any other type of model configured to include noise in data samples, and may take various forms. For example, the noise model 403 may be configured to include, in the denoised data samples, additive noise, multiplicative noise, a combination of additive and multiplicative noise, signal dependent noise, white and correlated noise, etc. One or more noise samples and/or parameters may be used by the noise model 403 to include noise in the denoised data samples. For example, if the noise type is additive and/or multiplicative noise, one or more noise samples may be used by the noise model 403, and may be added and/or multiplied, by the noise model 403, to the denoised data samples. As another example, if the noise type is signal dependent noise, one or more noise parameters may be used by the noise model 403, and the noise model 403 may use the noise parameters to modulate, and/or perform convolution functions on, the denoised data samples. The one or more noise samples and/or parameters may be generated by a noise generator of the noise model 403 (e.g., noise generators 701, 801, 901). More details regarding including noise by a noise model are further described in connection with FIGS. 7-9.

The training of the denoising model 301 may generate better results if during the training process the noise model 403 takes a particular form to generate an expected type of noise (e.g., a type of noise included in the noisy data samples), that is known or expected to be typical for a specific sensor in a specific circumstance. In some examples, the noise is one or more sensor data recorded and/or measured with one or more sensors without actual measuring and/or sensing any specific object or target, for example, measuring environmental noise in a specific environment without measuring a speech in the specific environment, or measuring an image sensor noise without any actual image, e.g. in dark and and/or against solid gray background. In some examples, the one or more sensors may the same as used for recording and/or measuring the noisy data samples, or may be different one or more sensors.

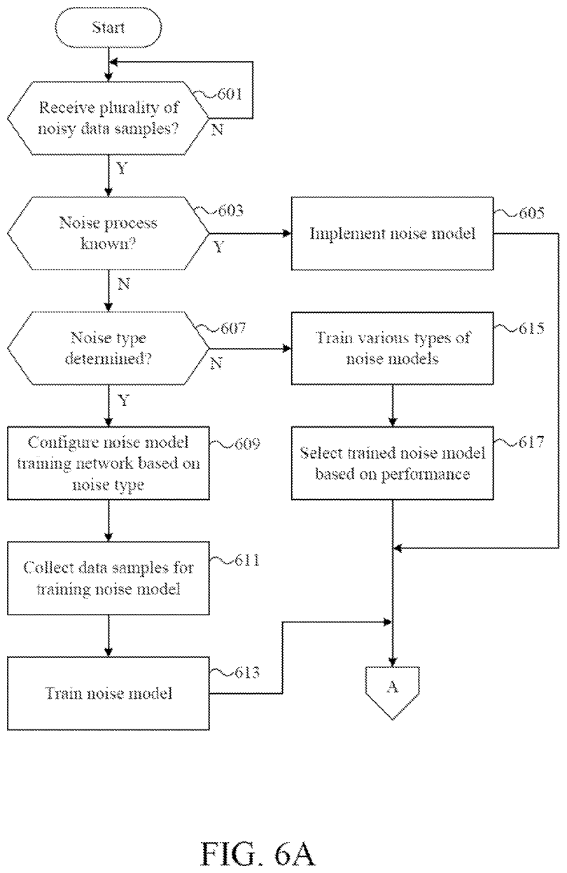

The noise included data samples may be input into the discriminator 405. The discriminator 405 may determine whether its input data belongs to a class of real noisy data samples (e.g., noisy data samples from the noisy data sample source 401) or a class of fake noisy data samples (e.g., the noise included data samples). The discriminator 405 may generate a discrimination value indicating the determination. For example, the discrimination value may comprise a probability p (and/or a scalar quality value, for example, in the case of a Wasserstein GAN) that the input data is a real noisy data sample. The probability (and/or a scalar quality value) that the input data is a fake noisy data sample may correspond to 1−p. The discriminator 405 may comprise, for example, a neural network. An example discriminator neural network is described in connection with FIG. 5.

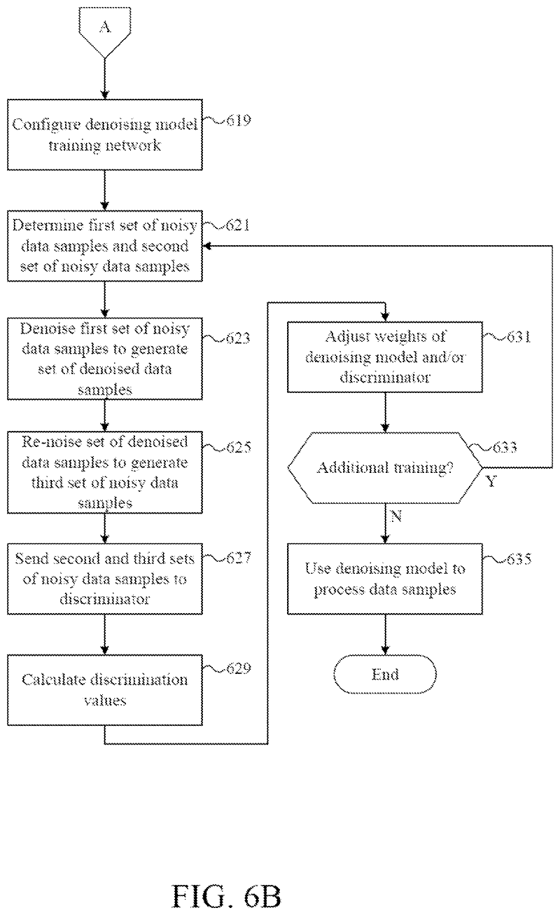

The denoising model 301 (acting as a generator) and the discriminator 405 may comprise a GAN. The denoising model 301 and/or the discriminator 405 may be trained in turn based on comparing the discrimination value with the ground truth and/or the target of the generator (e.g., to “fool” the discriminator 405 so that the discriminator 405 may treat data samples from the noise model 403 as real noisy data samples). For example, a loss value corresponding to the discrimination value and the ground truth may be calculated, and the weights and/or other parameters of the denoising model 301 and/or the discriminator 405 may be adjusted using stochastic gradient descent and backpropagation based on the loss value. Any kind of GAN training and setup may be used in conjugation with this proposal, including DRAGAN, RelativisticGAN, WGAN-GP, etc. Regularization (e.g., Spectral normalization, batch normalization, layer normalization, R1 or gradient penalty WGAN-GP) may improve the results. More details regarding training a denoising model are further discuss in connection with FIGS. 6A-6B.

As an example of a process for training an image denoising model, noisy images 451, 457 (e.g., image files) may be received from the noisy data sample source 401. The noisy image 451 may indicate a number “2” with its lower right corner blocked (e.g., through block dropout noise). The noisy image 457 may indicate a number “4” with its upper portion blocked (e.g., through block dropout noise). The denoising model 301 (e.g., an image denoising model) may process the noisy image 451, and may output a denoised image 453. The denoised image 453 may indicate a number “2” in its entirety. The noise model 403 (e.g., an image noise model) may process the denoised image 453 (e.g., by introducing, to the denoised image 453, a same type of noise that is included in the noisy images 451, 457), and may output a noisy image 455. The noise instance included in the noisy image 455 by the noise model 403 (e.g., block dropout noise at the lower left corner of the image) may be different from the noise instance included in the noisy image 451 (e.g., block dropout noise at the lower right corner of the image).

The discriminator 405 may receive the noisy images 455, 457, and may generate discrimination values corresponding to the noisy images 455, 457. The discriminator 405 and/or the denoising model 301 may be trained based on the loss value computed from the discrimination values and the ground truth using stochastic gradient descent and backpropagation. The ground truth is the binary value indicating whether the data sample was fake or real noisy data sample. The denoising model 301 may be trained to denoise its input into a clean estimate, as the denoising model 301 may not be able to observe the processing, by the noise model 403, of the output of the denoising model 301. For example, the denoising model 301 does not know which part of the denoised image 453 may be blocked by the noise model 403, and the denoising model 301 may have to learn to denoise the entire image.

FIG. 5 is a schematic diagram showing an example discriminator 405. The discriminator 405 may comprise, for example, an artificial neural network (ANN), a multilayer perceptron (e.g., the neural network 100), a convolutional neural network (e.g., the neural network 200), a recurrent neural network, a deep neural network, or any other type of neural network. For example, the discriminator 405 may include an input layer 501, one or more hidden layers (e.g., the discriminator layers 503A-503N), and an output layer 505. Each layer of the discriminator 405 may include one or more nodes. The nodes in the input layer 501 may receive a real noisy data sample from the noisy data sample source 401 or a noise included data sample from the denoising model 301 and the noise model 403. The received data may flow through the discriminator layers 503A-503N to the output layer 505. The output layer 505 may, for example, include one or more nodes (e.g., node 507). The value of the node 507 may, for example, indicate a probability (and/or a scalar quality value, for example, in the case of a Wasserstein GAN) that the input data of the discriminator 405 may belong to the class of real noisy data samples. The probability (and/or scalar quality value) that the input data of the discriminator 405 may belong to the class of fake noisy data samples may correspond to 1−p.

The nodes in one layer (e.g., the input layer 501) of the discriminator 405 may be mapped to the nodes in a next layer (e.g., the discriminator layer 503A) via one or more functions. For example, convolution functions, Leaky ReLU functions, and/or pooling functions may be applied to the nodes in the input layer 501, and the nodes in the discriminator layer 503A may hold the results of the functions. The discriminator model 405 may additionally or alternatively include skip connections inside the discriminator and/or skip connections inside it, similar to a residual net (ResNet) or dense net (DenseNet).

The discriminator 405 may comprise a switch 551. The switch 551 may be configured to (e.g., randomly) select from input data samples (e.g., noisy data samples from the noisy data sample source 401, noisy data samples measured by sensors from the environment, noisy data samples generated by the noise model 403, etc.), and send the selected input data sample(s) to the input layer 501 of the discriminator 405, so that the input layer 501 of the discriminator 405 may sometimes receive one or more real data samples (e.g., noisy data samples from the noisy data sample source 401, noisy data samples measured by sensors from the environment, etc.), and may sometimes receive one or more fake data samples (e.g., noisy data samples from the noise model 403, etc.).

FIGS. 6A-B are a flowchart showing an example method for training a denoising model, such as the denoising model 301. The method may be performed, for example, using one or more of the processes as discussed in connection with FIG. 4. The steps of the method may be described as being performed by particular components and/or computing devices for the sake of simplicity, but the steps may be performed by any component and/or computing device. The steps of the method may be performed by a single computing device or by multiple computing devices. One or more steps of the method may be omitted, added, and/or rearranged as desired by a person of ordinary skill in the art.

In step 601, a computing device (e.g., a computing device maintaining the noisy data sample source 401) may determine whether a plurality of noisy data samples is received. The noisy data sample source 401 may receive data samples captured by various types of sensors (e.g., images captured by image sensors, audio signals recorded by microphones, video signals recorded by recording devices, 3D scans measured by 3D scanners, etc.). Those data samples may include various types of noise included via the sensors and/or the environment in which the sensors may be located. As one example, the plurality of noisy data samples may have been measured by a particular sensor and/or in a particular environment, so that the denoising model trained may be specific to, and/or have better performance for, the sensor and/or environment. Additionally or alternatively, the computing device may receive one or more noisy data samples (e.g., periodically and/or in real-time) from one or more sensors and/or from other types of sources, and the received one or more noisy data samples may be used for training a denoising model.

If the computing device does not receive a plurality of noisy data samples (step 601: N), the method may repeat step 601. Otherwise (step 601: Y), the method may proceed to step 603. In step 603, the computing device may determine whether a noise process (e.g., noise source and/or noise type, etc.) associated with the plurality of noisy data samples is known. The noise process may include the mechanism via which noise was included and/or created in the plurality of noisy data samples. For example, if the computing device previously received data samples measured by the same one or more sensors and/or from the same environment as the currently received plurality of noisy data samples, and obtained a (e.g., trained and/or known) noise model for the previously received data, the computing device may use the noise model for processes associated with the currently received plurality of noisy data samples. Additionally or alternatively, an administrator and/or a user may know the noise process associated with the plurality of noisy data samples, and may input the noise process into the computing device.

If the noise process associated with the plurality of noisy data samples is known (step 603: Y), the method may proceed to step 605. In step 605, the computing device may implement the noise model (e.g., a mathematical expression with determined parameters) based on the known noise process. The implemented noise model may be used in training the denoising model 301. If the noise process associated with the plurality of noisy data samples is not known (step 603: N), the method may proceed to step 607. In step 607, the computing device may determine a noise type of the plurality of noisy data samples (e.g., based on the data sample type and/or the sensor type). For example, the computing device may store information (e.g., a database table) indicating one or more data types and/or signal types (e.g., image, audio signal, photoplethysmogram, video signal, 3D scan, etc.) and their corresponding noise types (e.g., additive noise, multiplicative noise, etc.). Additionally or alternatively, the computing device may also store information (e.g., a database table) indicating one or more types of sensors (e.g., camera, OCT device sensor, X-ray sensor, 3D scanner, microphone, etc.) and their corresponding noise types. For example, X-ray imaging may introduce signal dependent noise, and the information (e.g., the database table) may indicate the noise type corresponding to X-ray sensors is signal dependent.

If the computing device determines the noise type of the plurality of noisy data samples (step 607: Y), the method may proceed to step 609. In step 609, the computing device may configure a machine learning (ML) network for training the noise model based on the noise type as determined in step 607. For different types of noise (e.g., additive noise, multiplicative noise, signal dependent noise, etc.), the noise model training network may take different and/or additional forms. For example, if the noise type as determined in step 607 is additive noise, the computing device may configure a noise model training network corresponding to additive noise. More details regarding various forms of noise model training networks are further discussed in connection with FIGS. 7-9.

In step 611, the computing device may collect data samples to be used for training the noise model. The data samples for training the noise model may be measured and/or obtained using the same one or more sensors and/or from the same environment as the plurality of noisy data samples received in step 601 were measured and/or obtained, and/or may be collected based on the noise type as determined in the step 607. For example, if the noise type as determined in step 607 is additive noise, and the noise model to be trained is an additive noise model, the computing device may collect data samples including pure noise of the environment measured and/or recorded by the sensor and/or caused by the sensor itself As another example, if the noise type as determined in step 607 is multiplicative noise, the computing device may generate a non-zero signal (e.g., a white background for images, a constant frequency/volume sound for audio signals, etc.) to the environment, and may measure the signal using the sensor from the environment. As another example, if the noise type as determined in step 607 is signal dependent, the computing device may generate a signal with varying magnitude (e.g., a multiple-color background for images, a sound with varying frequency/volume for audio signals, etc.) to the environment, and may measure the signal using the sensor from the environment.

In step 613, the computing device may train the noise model using the ML training network configured in step 609 and based on the data samples collected in step 611. The computing device may use a GAN framework for training the noise model, and may train the noise model (as the generator of the GAN) and the discriminator of the GAN jointly and in turn. The computing device may use suitable techniques used for GAN training (e.g., backpropagation, stochastic gradient descent (SGD), etc.) to train the noise model. More details regarding training various types of noise models are further discussed in connection with FIGS. 7-9.

If the noise type of the plurality of noisy data samples is not determined (step 607: N), the method may proceed to step 615. For example, the noise type of the plurality of noisy data samples might not be determined if there is no information (e.g., no record in the database) indicating the noise type corresponding to the data sample type and/or the sensor type of the plurality of noisy data samples. In step 615, the computing device may train one or more noise models corresponding to one or more types of noise. For example, the computing device may train a noise model for additive noise, a noise model for multiplicative noise, and a noise model for signal dependent noise. In step 617, the computing device may select, from the one or more trained noise models, a noise model to be used for training the denoising model 301.

The selection may be performed based on the performance of each trained noise model. Additionally or alternatively, the computing device may train a denoising model based on and corresponding to each trained noise model, and may select, from the trained denoising models, a denoising model with the best performance. A performance metric that may be used to evaluate and/or select trained noise models and/or trained denoising models may be based on known characteristics of the data expected to be output by the models. Additionally or alternatively, the evaluation and/or selection may be a semi-automatic process based on quality ratings from users.

Referring to FIG. 6B, in step 619, the computing device may configure a ML network for training the denoising model 301. For example, the computing device may use, as the denoising model training network, the example process as discussed in connection with FIG. 4. In step 621, the computing device may determine, from the plurality of noisy data samples received in step 601, a first set of noisy data samples and a second set of noisy data samples. For example, the first set of the noisy data samples and the second set of the noisy data samples may be selected randomly (or shuffled) as subsets of the plurality of the noisy data samples (e.g., following the stochastic gradient descent training method). Additionally or alternatively, each of the first set of noisy data samples and the second set of noisy data samples may include all of the plurality of noisy data samples received in step 601 (e.g., following the standard gradient descent training method). Each of the first set of the noisy data samples and the second set of the noisy data samples may comprise one or more noisy data samples. The first set of the noisy data samples may have same members as, or different members from, the second set of the noisy data samples.

For example, the plurality of noisy data samples received in step 601 may comprise N data samples. Each of the first set of noisy data samples and the second set of noisy data samples may comprise one (1) data sample from the plurality of noisy data samples (e.g., following the stochastic gradient descent approach). Additionally or alternatively, each of the first set of noisy data samples and the second set of noisy data samples may comprise two (2) or more (and less than N) data samples from the plurality of noisy data samples (e.g., following the mini-batch stochastic gradient descent approach). Additionally or alternatively, each of the first set of noisy data samples and the second set of noisy data samples may comprise N data samples from the plurality of noisy data samples (e.g., comprise all of the plurality of noisy data samples) (e.g., following the gradient descent approach). Each of the first set of the noisy data samples and the second set of the noisy data samples may comprise one or more noisy data samples.

In step 623, the computing device may use the denoising model 301 to process the first set of the noisy data samples, and may generate a set of denoised data samples as the output of the processing. For example, each noisy data sample in the first set that was received by the input layer 311 of the denoising model 301 may flow through the encoder layers 313A-313N and the decoder layers 315A-315N to the output layer 319. The output layer 319 may produce a denoised data sample corresponding to an input noisy data sample. Additionally or alternatively, the computing device may adjust the value(s) of the random vector z 317 for each input noisy data sample, and may produce one or more denoised data samples corresponding to each input noisy data sample. Based on the performance of the denoising model 301, the denoised data samples may be partially denoised (e.g., noise may remain in the denoised data samples).

In step 625, the computing device may use the noise model as implemented in step 605, as trained in step 613, or as selected in step 617 to process the set of denoised data samples, and may generate a third set of noisy data samples as the output of the processing. The noise model may take various forms based on the type of noise associated with the plurality of the noisy data samples received in step 601. For example, noise may be added to the denoised data samples if the noise type is additive noise, noise may be multiplied to the denoised data samples if the noise type is multiplicative, noise may be included in the denoised data samples via a modulation function, a convolution function, and/or other types of functions, if the noise type is signal dependent, or any combination thereof.

In step 627, the computing device may send the second set of the noisy data samples and the third set of the noisy data samples to the discriminator 405. The discriminator 405 may process each noisy data sample in the second set and/or the third set. In step 629, the computing device may use the discriminator 405 to calculate one or more discrimination values. For example, each noisy data sample in the second set and/or the third set may be received by the input layer 501 of the discriminator 405 (e.g., via the switch 551 of the discriminator 405), and may flow through the discriminator layers 503A-503N to the output layer 505. When the input layer 501 receives a particular noisy data sample, the discriminator 405 might not know whether the particular noisy data sample comes from the noise model 403 or the noisy data sample source 401.

The output layer 505 may produce a discrimination value corresponding to an input noisy data sample to the discriminator 405. The discrimination value may be determined based on the input noisy data sample itself The discrimination value may, for example, comprise a probability p (and/or a scalar quality value, for example, in the case of a Wasserstein GAN) that the input data sample belongs to a class of real noisy data samples (e.g., noisy data samples from the noisy data sample source 401, noisy data samples measured by sensors from the environment, etc.). Then 1−p may indicate a probability (and/or scalar quality value) that the input data sample belongs to a class of fake noisy data samples (e.g., noisy data samples generated by the noise model 403, etc.). In case of probabilities, a sigmoid function may be used to restrict the range of the output strictly between 0 and 1, thus normalizing the output as probability value.

In step 631, the computing device may adjust, based on the discrimination values, the weights and/or other parameters (e.g., the weights of the connections between the nodes, the matrices used for the convolution functions, etc.) of the denoising model 301 and/or the discriminator 405. The denoising model 301 and the discriminator 405 may comprise a GAN, and may be trained jointly and in turn based on suitable techniques used for GAN training.

The computing device may adjust the weights and/or other parameters of the discriminator 405. The computing device may compare the discrimination values with ground truth data. The ground truth of a particular noisy data sample may indicate whether the noisy data sample in fact comes from the noisy data sample source 401 or from combination of the denoising model 301 and the noise model 403. A loss value may be calculated for the noisy data sample based on a comparison between a discrimination value corresponding to the noisy data sample and the ground truth of the noisy data sample. For example, if the discrimination value for the noisy data sample is 0.52, and the ground truth for the noisy data sample is 1, the loss value may correspond to 0.48, the ground truth minus the discrimination value.

The weights and/or other parameters of the discriminator 405 may be adjusted in such a manner that the discrimination value may approach the ground truth (e.g., proportional to the magnitude of the loss value). The weights and/or other parameters of the discriminator 405 may be modified, for example, using backpropagation. For example, the computing device may first adjust weights and/or other parameters associated with one or more nodes in a discriminator layer (e.g., the discriminator 503N) preceding the output layer 505 of the discriminator 405, and may then sequentially adjust weights and/or other parameters associated with each preceding layer of the discriminator 405. For example, if the value of a particular node (e.g., the discrimination value of the output node 507) is expected to be increased by a particular amount (e.g., by the loss value), the computing device may, for example, increase the weights associated with connections that positively contributed to the value of the node (e.g., proportional to the loss value), and may decrease the weights associated with connections that negatively contributed to the value of the node. Any desired backpropagation algorithm(s) may be used.

Additionally or alternatively, a loss function, of the weights and/or other parameters of the discriminator, correspond to the loss value may be determined, and a gradient of the loss function at the current values of the weights and/or other parameters of the discriminator may be calculated. The weights and/or other parameters of the discriminator may be adjusted proportional to the negative of the gradient. When adjusting the weights and/or other parameters of the discriminator, the computing device may hold the weights and/or other parameters of the denoising model 301 fixed.

Additionally or alternatively, when probability values are used as the output node 507, binary cross-entropy can be used as the loss function: −y*log(p)−(1−y)*log(1−p)), where p is the output of 507 of the discriminator (discrimination value) and y is the ground truth. For example, if the discrimination value for the noisy data sample is 0.52, and the ground truth for the noisy data sample is 1, the cross-entropy loss component in this example would become −log(p)=−log(0.52)≈0.65. In the case of Wasserstein GAN, the loss would be abs(y−p), where y would be in the range −1 to 1, therefore resulting in abs(1−0.52)=0.48. The elementwise sum or average of the loss vector may indicate that the weights and/or other parameters of the discriminator may be adjusted in such a manner that the discrimination value may be increased (e.g., proportional to the elementwise sum or average of the corresponding loss vector). The weights and/or other parameters of the discriminator 405 may be modified (e.g., by first differentiating the network with respect to the loss using backpropagation).

Additionally or alternatively, the computing device may adjust the weights and/or other parameters of the denoising model 301. The weights and/or other parameters of the denoising model 301 may be adjusted based on whether the discriminator 405 successfully detected the fake noisy data samples created by the denoising model 301 and the noise model 403. For example, the weights and/or other parameters of the denoising model 301 may be adjusted in such a manner that the discriminator 405 would treat a data sample from the denoising model 301 and the noise model 403 as a real noisy data sample.

The computing device may compare the discrimination values with the target of the denoising model 301 (and/or the ground truth data). The target of the denoising model 301 may be to generate data samples that the discriminator 405 may label as real. A target value may be set to be 1 (e.g., indicating real noisy data samples)). A loss value may be calculated based on comparing a discrimination value and the target value (and/or the ground truth data). And the computing device may adjust the weights and/or other parameters of the denoising model 301 (e.g., using backpropagation) in such a manner that the discrimination value approaches the target value (and/or moves away from the ground truth, corresponding to the data sample from the denoising model 301 and the noise model 403, that the data sample is fake). When adjusting the weights and/or other parameters of the denoising model 301, the computing device may hold the weights and/or other parameters of the discriminator 405 fixed, and the noise model 403 may be treated as a constant mapping function. The computing device may backpropagate through the discriminator 405 and the noise model 403 to adjust the weights and/or other parameters of the denoising model 301.

Additionally or alternatively, the denoising model 301 may be trained based on processing partial data samples. For example, in step 623, the computing device may use the denoising model 301 to process a portion of each of the first set of noisy data samples if the noise included in the training data samples are not spatially correlated (e.g., the noise in the upper section of a training image is not correlated with the noise in the lower section of a training image). For example, if the noise included in the training data samples is Gaussian noise, the computing device may use the noising model 301 to process a portion of the training data sample. The computing device may determine whether the noise is spatially correlated based on the noise type as determined in step 607 and/or based on the noise model used in training the denoising model 301. For example, if the noise type as determined in step 607 is Gaussian noise, the computing device may determine that the noise is not spatially correlated. The computing device may store information (e.g., a database table) indicating each type of noise and whether it is spatially correlated.

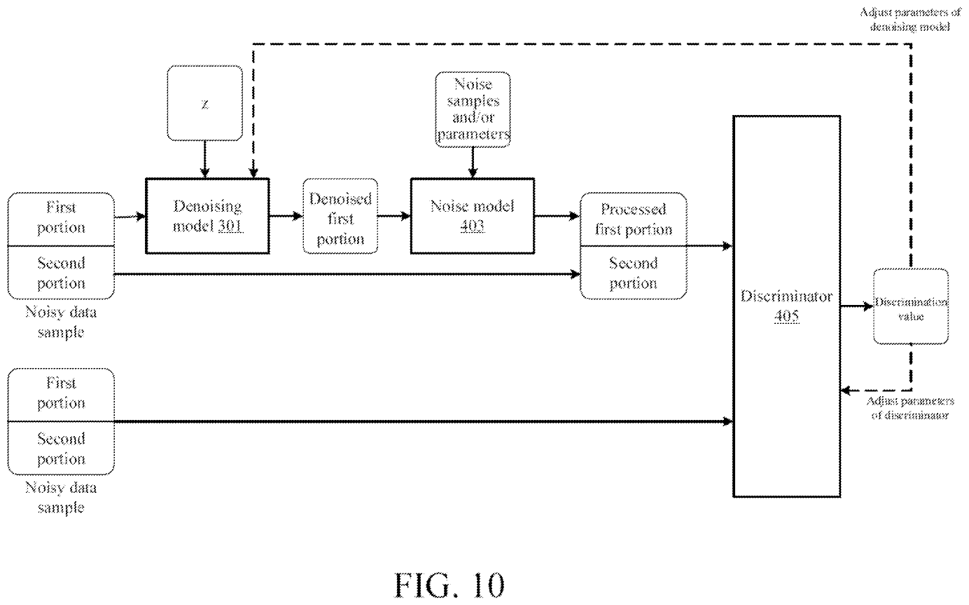

FIG. 10 shows an example process for training a denoising model based on processing partial data samples. With reference to FIG. 10, each noisy data sample of the first set of noisy data samples and the second set of noisy data samples may have one or more portions (e.g., a first portion and a second portion). The first portion of a noisy data sample may be processed by the denoising model 301 and the noise model 403. The output of the noise model 403 may be combined with the second portion of the noisy data sample, and the combination may be input into the discriminator 405. Additionally, noisy data samples (e.g., of the second set of noisy data samples) may be input into the discriminator 405. The discriminator 405 may calculate discrimination values based on its input data samples.

Additionally or alternatively, the entirety of a noisy data sample (e.g., the first portion of the noisy data sample and the second portion of the data sample) may be input into the denoising model 301. The denoising model 301 may generate a denoised portion corresponding to the first portion of the noisy data sample. The denoised portion may be processed by the noise model 403. The output of the noise model 403 may be combined with the second portion of the noisy data sample, and the combination may be input into the discriminator 405. Noisy data samples (e.g., of the second set of noisy data samples) may be input into the discriminator 405. The discriminator 405 may calculate discrimination values based on its input data samples.

Partial processing of data samples during the training of the denoising model 301 may improve the performance of the discriminator 405 and/or the denoising model 301. For example, if training images include heavy Gaussian noise, the denoising model 301 may alter the color balance, brightness (mean), contrast (variance), and/or other attributes of the training image. By partially processing the training images, the discriminator 405 may become aware of the effects of changes in color, brightness, contract, and/or other attributes, and the denoising model 301 may accordingly be trained to avoid changing the attributes. Training a denoising model based on processing partial data samples may be used together with, or independent of, the processes of training a denoising model as described in connection with FIG. 4.

Referring back to FIG. 6B, in step 633, the computing device may determine whether additional training is to be performed. For example, the computing device may set an amount of time to be used for training the denoising model, and if the time has expired, the computing device may determine not to perform additional training. Additionally or alternatively, the computing device may use the denoising model to denoise noisy data samples, and an administrator and/or user may assess the performance of the denoising model. Additionally or alternatively, known statistics of the clean data (e.g., expected to be output by the denoising model) may be used in making this determination. Additionally or alternatively, if noisy data samples used for training are received by the computing device periodically and/or in real-time, the computing device may determine to perform additional training if and/or when new noisy data samples are received, and the additional training may be, for example, performed based on the newly received noisy data samples.

If additional training is to be performed (step 633: Y), the method may repeat step 621. In step 621, the computing device may determine another two sets of noisy data samples for another training session. If additional training is not to be performed (step 633: N), the method may proceed to step 635. In step 635, the trained denoising model may be used to process further noisy data samples (e.g., measured by sensors) to generate denoised data samples. The computing device may further deliver the denoised data as an input for further processing in the computing device or to other processes outside of the computing device. The further processing of the denoised data samples may comprise, for example, image recognition, object recognition, natural language processing, speech recognition, speech-to-text detection, heart rate monitoring, detection of physiological attributes, monitoring of physical features, location detection, etc. The computing device may also present the denoised data samples to users.

Additionally or alternatively, the computing device may deliver the trained denoising model to a second computing device. The second computing device may receive the trained denoising model, may use the trained denoising model to denoise data samples, for example, from a sensor of the second computing device, and may present the denoised data samples to users or send the denoised data samples to another process for further processing. The sensor of the second computing device may be similar to one or more sensors that gathered data samples used for training the denoising model by the computing device. For example, the sensor of the second computing device may be of a same category as the one or more sensors. As another example, the sensor of the second computing device and the one or more sensors may have a same manufacturer, same (or similar) technical specifications, same (or similar) operating parameters, etc.

One or more steps of the example method may be omitted, added, and/or rearranged as desired by a person of ordinary skill in the art. Additionally or alternatively, the order of the steps of the example method may be altered without departing from the scope of the disclosure provided herein. For example, the computing device may be determined one or more discrimination values (e.g., in step 629), and then may determine whether additional training is to be performed (e.g., in step 633). If additional training is not to be performed, the computing device may adjust, based on determined discrimination values, weights and/or other parameters of the denoising model and/or the discriminator (e.g., in step 631). If additional training is to be performed, the computing device may determine additional sets of noisy data samples for the additional training (e.g., in step 621). The order of the steps may be altered in any other desired manner.

FIG. 7 is a schematic diagram showing an example process for training a noise model. The process may be implemented by one or more computing devices (e.g., the computing device described in connection with FIG. 11). The process may be distributed across multiple computing devices, or may be performed by a single computing device. For example, the process may be used to train an additive noise model. The process may use a noise generator 701 and a discriminator 703. The discriminator 703 may comprise, for example, an artificial neural network (ANN), a multilayer perceptron (e.g., the neural network 100), a convolutional neural network (e.g., the neural network 200), a recurrent neural network, a deep neural network, or any other type of neural network (e.g., similar to the discriminator 405), and may learn to classify input data as measured noise or generated noise.

The noise generator 701 may be configured to generate additive noise (e.g., Gaussian white noise, etc.). The noise generator 701 may comprise, for example, an artificial neural network (ANN), a multilayer perceptron (e.g., the neural network 100), a convolutional neural network (e.g., the neural network 200), a recurrent neural network, a deep neural network, or any other type of neural network configured to act as the generator of a GAN. The noise generator 701 may include an input layer for receiving a random vector z, one or more hidden layers, and an output layer for producing the generated noise (e.g., Gaussian white noise, etc.). The noise generator 701 may learn to map from a latent space (e.g., the random vector z) to a particular data distribution of interest (e.g., Gaussian white noise with certain parameters).

The noise generator 701 may be trained using suitable techniques for GAN training. For example, the noise generator 701 may receive one or more random vectors as input, and may generate one or more noise data samples, which may be input into the discriminator 703. Additionally, noise may be measured from the environment via the sensor as one or more noise data samples, which may be input into the discriminator 703. The noise model may be specific to the environment/sensor for which the denoising model 301 is trained. For example, if a denoising model and/or a noise model are to be trained for an audio sensor in a space (e.g., a factory or room) the computing device may measure pure noise samples via the sensor in the space. For example, the computing device may determine, using a speech detection component, periods when there is no speech in the space, and may record data samples during the periods. The data samples may be used to train a noise model for the audio sensor in the space.

The discriminator 703 may receive the generated noise data samples and the measured noise data samples. For example, each data sample may be received by an input layer of the discriminator 703. An output layer of the discriminator 703 may produce a discrimination value corresponding to an input data sample. The discrimination value may be determined based on the input data sample itself, and may indicate probabilities (and/or scalar quality values) that the input data sample belongs to measured noise or generated noise. The discrimination value may be compared with the ground truth and/or the target of the noise generator 701 (e.g., to “fool” the discriminator 703 so that the discriminator 703 may treat generated noise data samples as measured noise), and the weights and/or other parameters of the discriminator 703 and/or the noise generator 701 may be adjusted in a similar manner as discussed in connection with training the denoising model 301 (e.g., in step 631).

After the noise generator 701 has been trained, it may be used to include noise to data samples (e.g., as part of the noise model 403 during training of the denoising model 301). For example, the noise model 403 may receive a denoised data sample from the denoising model 301. The noise generator 701 may receive a random vector z in its input layer, and may produce noise data in its output layer. The noise model 403 may receive the produced noise data as an input, may perform an addition function to combine the denoised data sample and the produced noise data, and may generate a noisy data sample corresponding to the denoised data sample.

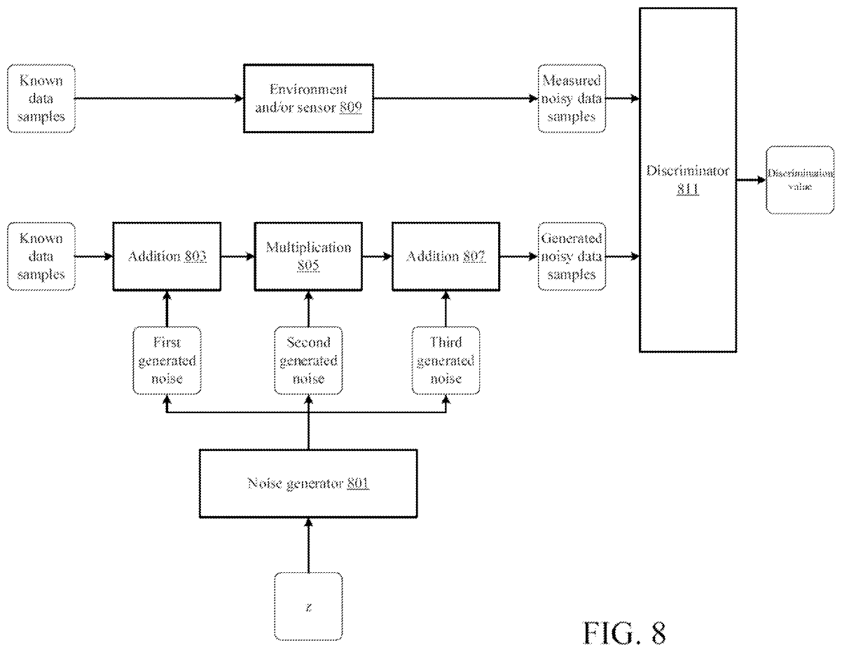

FIG. 8 is a schematic diagram showing another example process for training a noise model. The process may be implemented by one or more computing devices (e.g., the computing device described in connection with FIG. 11). The process may be distributed across multiple computing devices, or may be performed by a single computing device. For example, the process may be used to train a noise model for additive and/or multiplicative noise. The process may use a noise generator 801, one or more addition functions (e.g., addition functions 803, 807), one or more multiplication functions (e.g., multiplication function 805), an environment and/or sensor 809, and a discriminator 811. The discriminator 811 may comprise, for example, an artificial neural network (ANN), a multilayer perceptron (e.g., the neural network 100), a convolutional neural network (e.g., the neural network 200), a recurrent neural network, a deep neural network, or any other type of neural network (e.g., similar to the discriminator 405), and may learn to classify input data as measured noisy data samples or generated noisy data samples.

The noise generator 801 may be configured to generate additive noise (e.g., Gaussian white noise, etc.) and/or multiplicative noise (e.g., dropout noise, etc.). The noise generator 801 may comprise, for example, an artificial neural network (ANN), a multilayer perceptron (e.g., the neural network 100), a convolutional neural network (e.g., the neural network 200), a recurrent neural network, a deep neural network, or any other type of neural network configured to act as the generator of a GAN. The noise generator 801 may include an input layer for receiving a random vector z, one or more hidden layers, and an output layer for producing first generated noise (e.g., Gaussian white noise, etc.), second generated noise (e.g., dropout noise, etc.), and third generated noise (e.g., Gaussian white noise, etc.). The noise generator 801 may learn to map from a latent space (e.g., the random vector z) to particular data distributions of interest (e.g., Gaussian white noise with certain parameters, dropout noise with certain parameters, etc., or any combinations of different noise types).

The noise generator 801 may be trained using suitable techniques for GAN training. For example, the noise generator 801 may receive one or more random vectors as input, and may generate one or more first noise data samples, one or more second noise data samples, and one or more third noise data samples. The first noise data samples may be input into the addition function 803, which may add the first noise data samples to known data samples. The second noise data samples may be input into the multiplication function 805, which may multiply the second noise data samples with the output of the addition function 803. The third noise data samples may be input into the addition function 807, which may add the third noise data samples with the output of the multiplication function 805. The noise generator 801, the addition functions 803, 807, and the multiplication function 805 may comprise a noise model for additional noise and/or multiplicative noise. The noise model may receive known data samples, may include noise in the known data samples, and may output generated noisy data samples. The generated noisy data samples may be input into the discriminator 811.

Additionally, the known data samples may be produced in the environment, and may be measured from the environment as one or more measured noisy data samples, which may be input into the discriminator 811. The known data samples may have non-zero data values. For example, a white background may be produced, and a camera may take an image of the white background. The image may be used as a measured noisy data sample for training the noise model.

The discriminator 811 may receive the generated noisy data samples and the measured noisy data samples. For example, each data sample may be received by an input layer of the discriminator 811. An output layer of the discriminator 811 may produce a discrimination value corresponding to an input data sample. The discrimination value may be determined based on the input data sample itself, and may indicate probabilities (and/or scalar quality values) that the input data sample belongs to measured noisy data samples or generated noisy data samples. The discrimination value may be compared with the ground truth and/or the target of the noise generator 801 (e.g., to “fool” the discriminator 811 so that the discriminator 811 may treat generated noisy data samples as measured noisy data samples), and the weights and/or other parameters of the discriminator 811 and/or the noise generator 801 may be adjusted in a similar manner as discussed in connection with training the denoising model 301 (e.g., in step 631).

After the noise generator 801 has been trained, it may be used to include noise to data samples (e.g., as part of the noise model 403 during training of the denoising model 301 similar to the process in FIG. 7). For example, the noise generator 801, the addition functions 803, 807, and the multiplication function 805 may comprise the noise model 403 for additional noise and/or multiplicative noise. The noise model 403 may receive a denoised data sample from the denoising model 301. The noise generator 801 may receive a random vector z in its input layer, and may produce noise data in its output layer. The noise model 403 may perform addition functions and/or multiplication functions on the denoised data sample and the noise data, and may generate a noisy data sample corresponding to the denoised data sample.

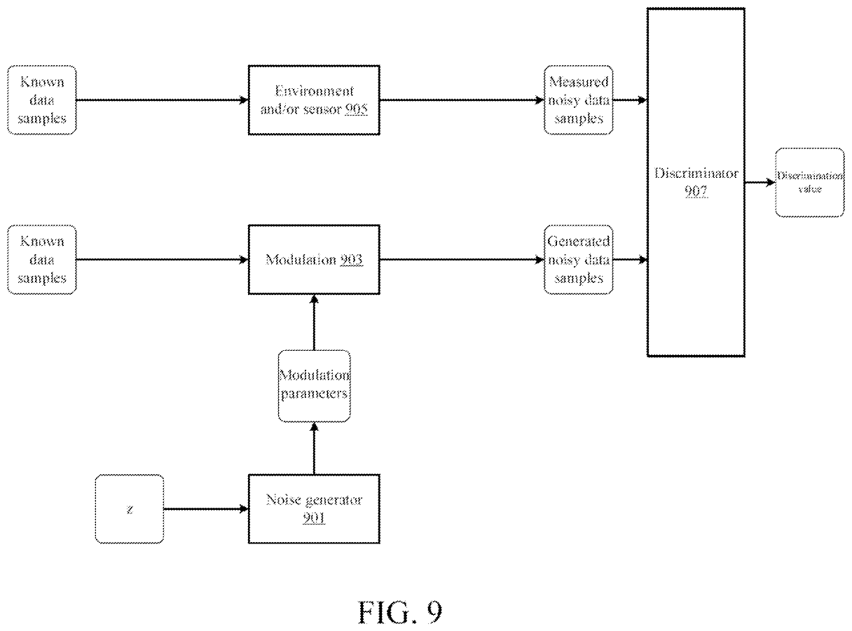

FIG. 9 is a schematic diagram showing another example process for training a noise model. The process may be implemented by one or more computing devices (e.g., the computing device described in connection with FIG. 11). The process may be distributed across multiple computing devices, or may be performed by a single computing device. For example, the process may be used to train a noise model for signal dependent noise (e.g., noise in X-ray medical images). The process may use a noise generator 901, a modulation function 903, an environment and/or sensor 905, and a discriminator 907. The discriminator 907 may comprise, for example, an artificial neural network (ANN), a multilayer perceptron (e.g., the neural network 100), a convolutional neural network (e.g., the neural network 200), a recurrent neural network, a deep neural network, or any other type of neural network (e.g., similar to the discriminator 405), and may learn to classify input data as measured noisy data samples or generated noisy data samples. The modulation function 903 may be configured to introduce noise to data samples by modulating the data samples. For example, if Y(x) represents the output of the modulation function 903, and x represents the input data sample of the modulation function 903, the modulation function 903 may be implemented according to the following equation:

$$Y ( x ) = {G}_{m 2} ( z ) {x}^{1 / 2} + {G}_{0} ( z ) + {G}_{1} ( z ) x + {G}_{2} ( z ) {x}^{2}$$

The noise generator 901 may be configured to generate modulation parameters for the modulation function 903 (e.g., Gₘ₂(z), G₀(z), G₁(z), and G₂(z)). Additionally or alternatively, the modulation function 903 may take various other forms (e.g., convolution) based on the noise type. For example, one or more convolution functions may be used in the place of the modulation function 903. The convolution function(s) may be configured to, for example, blur images, filter certain frequencies of audio signals, create echoes in audio signals, etc. The noise generator 901 may comprise, for example, an artificial neural network (ANN), a multilayer perceptron (e.g., the neural network 100), a convolutional neural network (e.g., the neural network 200), a recurrent neural network, a deep neural network, or any other type of neural network configured to act as the generator of a GAN. The noise generator 901 may include an input layer for receiving a random vector z, one or more hidden layers, and an output layer for producing the modulation parameters. The noise generator 901 may learn to map from a latent space (e.g., the random vector z) to a particular data distribution of interest (e.g., certain modulation parameters). Additionally or alternatively, the noise generator 901 may output one or more parameters to the one or more convolution functions (and/or other types of functions) for introducing signal dependent noise to data samples.

The noise generator 901 may be trained using suitable techniques for GAN training. For example, the noise generator 901 may receive one or more random vectors as input, and may generate one or more sets of modulation parameters (and/or convolution parameters). The sets of modulation parameters (and/or convolution parameters) may be input into the modulation (and/or convolution) function 903, which may use the modulation parameters (and/or convolution parameters) to modulate (and/or to perform the convolution function(s) on) known data samples, and may generate noisy data samples corresponding to the known data samples. The noise generator 901 and the modulation (and/or convolution) function 903 may comprise a noise model for signal dependent noise. The noise model may receive known data samples, may include noise in the known data samples, and may output generated noisy data samples. The generated noisy data samples may be input into the discriminator 907.

Additionally, the known data samples may be produced in the environment, and may be measured from the environment as one or more measured noisy data samples, which may be input into the discriminator 907. The known data samples may have varying non-zero data values. For example, a multiple-color background may be produced, and a camera may take an image of the background. The image may be used as a measured noisy data sample for training the noise model.

The discriminator 907 may receive the generated noisy data samples and the measured noisy data samples. For example, each data sample may be received by an input layer of the discriminator 907. An output layer of the discriminator 907 may produce a discrimination value corresponding to an input data sample. The discrimination value may be determined based on the input data sample itself, and may indicate probabilities (and/or scalar quality values) that the input data sample belongs to measured noisy data samples or generated noisy data samples. The discrimination value may be compared with the ground truth and/or the target of the noise generator 901 (e.g., to “fool” the discriminator 907 so that the discriminator 907 may treat generated noisy data samples as measured noisy data samples), and the weights and/or other parameters of the discriminator 907 and/or the noise generator 901 may be adjusted in a similar manner as discussed in connection with training the denoising model 301 (e.g., in step 631).

After the noise generator 901 has been trained, it may be used to include noise to data samples (e.g., as part of the noise model 403 during training of the denoising model 301 similar to the process in FIG. 7). For example, the noise generator 901 and the modulation (and/or convolution) function 903 may comprise the noise model 403 for signal dependent noise. The noise model 403 may receive a denoised data sample from the denoising model 301. The noise generator 901 may receive a random vector z in its input layer, and may produce modulation (and/or convolution) parameters in its output layer. The noise model 403 may perform, based on the modulation (and/or convolution) parameters, modulation (and/or convolution) function on the denoised data sample, and may generate a noisy data sample corresponding to the denoised data sample.

FIG. 11 illustrates an example apparatus, in particular a computing device 1112 or one or more communicatively connected (1141, 1141, 1143, 1144 and/or 1145) computing devices 1112, that may be used to implement any or all of the example processes in FIGS. 3A-3B, 4-5, 7-10, and/or other computing devices to perform the steps described above and in FIGS. 6A-6B. Computing device 1112 may include a controller 1125. The controller 1125 may be connected to a user interface control 1130, display 1136 and/or other elements as shown. Controller 1125 may include one or more circuitry, such as for example one or more processors 1128 and one or more memory 1134 storing one or more software 1140 (e.g., computer executable instructions). The software 1140 may comprise, for example, one or more of the following software options: user interface software, server software, etc., including the denoising model 301, the noisy data sample source 401, the noise model 403, the discriminators 405, 703, 811, 907, the noise generators 701, 801, 901, the addition functions 803, 807, the multiplication function 805, the modulation (and/or convolution) function 903, one or more GAN processes, etc.

Device 1112 may also include a battery 1150 or other power supply device, speaker 1153, and one or more antennae 1154. Device 1112 may include user interface circuitry, such as user interface control 1130. User interface control 1130 may include controllers or adapters, and other circuitry, configured to receive input from or provide output to a keypad, touch screen, voice interface—for example via microphone 1156, function keys, joystick, data glove, mouse and the like. The user interface circuitry and user interface software may be configured to facilitate user control of at least some functions of device 1112 though use of a display 1136.

Display 1136 may be configured to display at least a portion of a user interface of device 1112. Additionally, the display may be configured to facilitate user control of at least some functions of the device (for example, display 1136 could be a touch screen). Device 1112 may also include one or more internal sensors and/or connected to one or more external sensors 1157. The sensor 1157 may include, for example, a still/video image sensor, a 3D scanner, a video recording sensor, an audio recording sensor, a photoplethysmogram sensor device, an optical coherence tomography imaging sensor, an X-ray imaging sensor, an electroencephalography sensor, a physiological sensor (such as heart rate (HR) sensor, thermometer, respiration rate (RR) sensor, carbon dioxide (CO2) sensor, oxygen saturation (SpO2) sensor), a chemical sensor, a biosensor, an environmental sensor, a radar, a motion sensor, an accelerometer, an inertial measurement unit (IMU), a microphone, a Global Navigation Satellite System (GNSS) receiver unit, a position sensor, an antenna, a wireless receiver, etc., or any combination thereof.

Software 1140 may be stored within memory 1134 to provide instructions to processor 1128 such that when the instructions are executed, processor 1128, device 1112 and/or other components of device 1112 are caused to perform various functions or methods such as those described herein (for example, as depicted in FIGS. 3A-3B, 4-5, 6A-6B, 7-10). The software may comprise machine executable instructions and data used by processor 1128 and other components of computing device 1112 and may be stored in a storage facility such as memory 1134 and/or in hardware logic in an integrated circuit, ASIC, etc. Software may include both applications and/or services and operating system software, and may include code segments, instructions, applets, pre-compiled code, compiled code, computer programs, program modules, engines, program logic, and combinations thereof.

Memory 1134 may include any of various types of tangible machine-readable storage medium, including one or more of the following types of storage devices: read only memory (ROM) modules, random access memory (RAM) modules, magnetic tape, magnetic discs (for example, a fixed hard disk drive or a removable floppy disk), optical disk (for example, a CD-ROM disc, a CD-RW disc, a DVD disc), flash memory, and EEPROM memory. As used herein (including the claims), a tangible or non-transitory machine-readable storage medium is a physical structure that may be touched by a human A signal would not by itself constitute a tangible or non-transitory machine-readable storage medium, although other embodiments may include signals or ephemeral versions of instructions executable by one or more processors to carry out one or more of the operations described herein.

As used herein, processor 1128 (and any other processor or computer described herein) may include any of various types of processors whether used alone or in combination with executable instructions stored in a memory or other computer-readable storage medium. Processors should be understood to encompass any of various types of computing structures including, but not limited to, one or more microprocessors, special-purpose computer chips, field-programmable gate arrays (FPGAs), controllers, application-specific integrated circuits (ASICs), hardware accelerators, graphical processing units (GPUs), AI (artificial intelligence) accelerators, digital signal processors, software defined radio components, combinations of hardware/firmware/software, or other special or general-purpose processing circuitry, or any combination thereof.

As used in this application, the term “circuitry” may refer to any of the following: (a) hardware-only circuit implementations (such as implementations in only analog and/or digital circuitry) and (b) combinations of circuits and software (and/or firmware), such as (as applicable): (i) a combination of processor(s) or (ii) portions of processor(s)/software (including digital signal processor(s)), software, and memory(ies) that work together to cause an apparatus, such as a mobile phone, server, or other computing device, to perform various functions) and (c) circuits, such as a microprocessor(s) or a portion of a microprocessor(s), that require software or firmware for operation, even if the software or firmware is not physically present.

These examples of “circuitry” apply to all uses of this term in this application, including in any claims. As an example, as used in this application, the term “circuitry” would also cover an implementation of merely a processor (or multiple processors) or portion of a processor and its (or their) accompanying software and/or firmware. The term “circuitry” would also cover, for example, a radio frequency circuit, a baseband integrated circuit or applications processor integrated circuit for a mobile phone or a similar integrated circuit in a server, a cellular network device, or other network device.

Device 1112 or its various components may be mobile and be configured to receive, decode and process various types of transmissions including transmissions in Wi-Fi networks according to wireless local area network (e.g., the IEEE 802.11 WLAN standards 802.11n, 802.11ac, etc.), short range wireless communication networks (e.g., near-field communication (NFC)), and/or wireless metro area network (WMAN) standards (e.g., 802.16), through one or more WLAN transceivers 1143 and/or one or more WMAN transceivers 1141. Additionally or alternatively, device 1112 may be configured to receive, decode and process transmissions through various other transceivers, such as FM/AM and/or television radio transceiver 1142, and telecommunications transceiver 1144 (e.g., cellular network receiver such as CDMA, GSM, 4G LTE, 5G, etc.). A wired interface 1145 (e.g., an Ethernet interface) may be configured to provide communication via a wired communication medium (e.g., fiber, cable, Ethernet, etc.).

Although the above description of FIG. 11 generally relates to an apparatus, such as the computing device 1112, other devices or systems may include the same or similar components and perform the same or similar functions and methods. For example, a mobile communication unit, a wired communication device, a media device, a navigation device, a computer, a server, a sensor device, an IoT (internet of things) device, a vehicle, a vehicle control unit, a smart speaker, a router, etc., or any combination thereof communicating over a wireless or wired network connection may include the components or a subset of the components described above which may be communicatively connected to each other, and may be configured to perform the same or similar functions as device 1112 and its components. Further computing devices as described herein may include the components, a subset of the components, or a multiple of the components (e.g., integrated in one or more servers) configured to perform the steps described herein.

Although specific examples of carrying out the disclosure have been described, those skilled in the art will appreciate that there are numerous variations and permutations of the above-described systems and methods that are contained within the spirit and scope of the disclosure. Any and all permutations, combinations, and sub-combinations of features described herein, including but not limited to features specifically recited in the claims, are within the scope of the disclosure.

1-55. (canceled)

56. A method comprising:
receiving, by a computing device, a first set of noisy data samples and a second set of noisy data samples;
denoising, using a first neural network comprising a first plurality of parameters, the first set of the noisy data samples to generate a set of denoised data samples;
processing, using a noise model, the set of the denoised data samples to generate a third set of noisy data samples;
determining, using a second neural network and based on the second set of the noisy data samples and the third set of the noisy data samples, a discrimination value; and
adjusting, based on the discrimination value, the first plurality of parameters.

57. The method of claim 56, wherein the first set of the noisy data samples comprises one or more first noisy images, one or more first noisy videos, one or more first noisy 3D scans, or one or more first noisy audio signals, and wherein the second set of the noisy data samples comprises one or more second noisy images, one or more second noisy videos, one or more second noisy 3D scans, or one or more second noisy audio signals.

58. The method of claim 56, further comprising:
training, based on additional noisy data samples and by further adjusting the first plurality of the parameters, the first neural network, such that the discrimination value approaches a predetermined value;
after the training of the first neural network, receiving a noisy data sample;
denoising, using the trained first neural network, the noisy data sample to generate a denoised data sample; and
presenting to a user, or sending for further processing, the denoised data sample.

59. The method of claim 56, further comprising:
training, based on additional noisy data samples and by further adjusting the first plurality of the parameters, the first neural network, such that the discrimination value approaches a predetermined value;
after the training of the first neural network, delivering the trained first neural network to a second computing device;
receiving a noisy data sample from a sensor of the second computing device;
denoising, by the second computing device and using the trained first neural network, the noisy data sample to generate a denoised data sample; and
presenting to a user, or sending for further processing, the denoised data sample.

60. The method of claim 56, wherein the first set of the noisy data samples and the second set of the noisy data samples are received from a same source.

61. The method of claim 59, wherein the first set of the noisy data samples, the second set of the noisy data samples, and the noisy data sample are received from a one or more similar sensors.

62. The method of claim 58, wherein the trained first neural network is a trained denoising model.

63. The method of claim 56, wherein the first neural network and the second neural network comprise a generative adversarial network.

64. The method of claim 56, wherein the second neural network comprises a second plurality of parameters, and wherein the adjusting the first plurality of the parameters is based on fixing the second plurality of the parameters, the method further comprising:
adjusting the second plurality of the parameters based on fixing the first plurality of the parameters.

65. The method of claim 56, wherein the discrimination value indicates a probability, or a scalar quality value, of a noisy data sample of the second set of the noisy data samples or of the third set of the noisy data samples belonging to a class of real noisy data samples or a class of fake noisy data samples.

66. The method of claim 56, further comprising:
determining, based on a type of a noise process through which the first set of noisy data samples and the second set of noisy data samples are generated, one or more noise types; and
determining, based on the one or more noise types, the noise model corresponding to the noise process.

67. The method of claim 56, wherein the noise model comprises a machine learning model comprising a third plurality of parameters, the method further comprising:
receiving a set of reference noise data samples;
generating, using the noise model, a set of generated noise data samples; and
training, using machine learning and based on the set of reference noise data samples and the set of generated noise data samples, the noise model.

68. The method of claim 67, wherein:
the noise model further comprises a modulation model configured to modulate data samples to generate noisy data samples, and the machine learning model outputs one or more coefficients to the modulation model; or
the noise model further comprises a convolutional model configured to perform convolution functions on data samples to generate noisy data samples, and the machine learning model outputs one or more parameters to the convolutional model.

69. The method of claim 66, further comprising:
training, using machine learning, one or more machine learning models corresponding to one or more noise types; and
selecting, from the one or more machine learning models, a machine learning model to be used as the noise model.

70. The method of claim 56, further comprising:
receiving, by the computing device, a fourth set of noisy data samples and a fifth set of noisy data samples, wherein each noisy data sample of the fourth set of the noisy data samples comprises a first portion and a second portion;
denoising, using the first neural network, the first portion of the each noisy data sample of the fourth set of noisy data samples;
processing, using the noise model, the denoised first portion of the each noisy data sample of the fourth set of the noisy data samples;
determining, using the second neural network and based on the processed denoised first portions, the second portions, and the fifth set of the noisy data samples, a second discrimination value; and
adjusting, based on the second discrimination value, the first plurality of the parameters.

71. An apparatus comprising:
one or more processors; and
one or more memory units storing instructions that, when executed by the one or more processors, configured to cause the apparatus to:
receive a first set of noisy data samples and a second set of noisy data samples;
denoise, using a first neural network comprising a first plurality of parameters, the first set of noisy data samples to generate a set of denoised data samples;
process, using a noise model, the set of denoised data samples to generate a third set of noisy data samples;
determine, using a second neural network and based on the second set of noisy data samples and the third set of noisy data samples, a discrimination value; and
adjust, based on the discrimination value, the first plurality of the parameters.

72. The apparatus of claim 71, wherein the instructions, when executed by the one or more processors, are further configured to cause the apparatus to:
train, based on additional noisy data samples and by further adjusting the first plurality of the parameters, the first neural network, such that the discrimination value approaches a predetermined value;
after the training of the first neural network, receive a noisy data sample;
denoise, using the trained first neural network, the noisy data sample to generate a denoised data sample; and
present to a user, or send for further processing, the denoised data sample.

73. The apparatus of claim 71, wherein the instructions, when executed by the one or more processors, are further configured to cause the apparatus to:
train, based on additional noisy data samples and by further adjusting the first plurality of the parameters, the first neural network, such that the discrimination value approaches a predetermined value; and
after the training of the first neural network, deliver the trained first neural network to a second apparatus.

74. The apparatus of claim 71, wherein the first set of the noisy data samples and the second set of the noisy data samples are received from a same source.

75. The apparatus of claim 72, wherein the trained first neural network is a trained denoising model.

76. The apparatus of claim 71, wherein the discrimination value indicates a probability, or a scalar quality value, of a noisy data sample of the second set of noisy data samples or of the third set of noisy data samples belonging to a class of real noisy data samples or a class of fake noisy data samples.

77. The apparatus of claim 71, wherein the noise model comprises a machine learning model comprising a third plurality of parameters, and wherein the instructions, when executed by the one or more processors, further cause the apparatus to:
receive a set of reference noise data samples;
generate, using the noise model, a set of generated noise data samples; and
train, using machine learning and based on the set of reference noise data samples and the set of generated noise data samples, the noise model.

78. The apparatus of claim 71, wherein the instructions, when executed by the one or more processors, are further configured to cause the apparatus to:
receive a fourth set of noisy data samples and a fifth set of noisy data samples, wherein each noisy data sample of the fourth set of noisy data samples comprises a first portion and a second portion;
denoise, using the first neural network, the first portion of the each noisy data sample of the fourth set of the noisy data samples;
process, using the noise model, the denoised first portion of the each noisy data sample of the fourth set of the noisy data samples;
determine, using the second neural network and based on the processed denoised first portions, the second portions, and the fifth set of the noisy data samples, a second discrimination value; and
adjust, based on the second discrimination value, the first plurality of the parameters.

79. An apparatus comprising:
one or more processors; and
memory storing instructions that, when executed by the one or more processors, cause the apparatus to:
receive a denoising model, wherein the denoising model is trained using a generative adversarial network;
receive a noisy data sample from a noisy sensor, wherein the denoising model is trained for a sensor similar to the noisy sensor;
denoise, using the denoising model, the noisy data sample to generate a denoised data sample; and
present to a user, or send for further processing, the denoised data sample;
wherein the further processing comprises at least one of image recognition, object recognition, natural language processing, voice recognition, or speech-to-text detection.
